(19) United States
(12) Patent Application Publication
(10) Pub. No.: US 2026/0178265 A1
(43) Pub. Date: Jun. 25, 2026

(54) ELECTRONIC DEVICE, METHOD, AND NON-TRANSITORY STORAGE MEDIUM FOR EDITING AUDIO

(71) Applicant: SAMSUNG ELECTRONICS CO., LTD., Suwon-si (KR)

(72) Inventors: Jaesik SOHN, Suwon-si (KR); Seoyeon Jang, Suwon-si (KR); Joonhyun Choi, Suwon-si (KR); Wonguen Cho, Suwon-si (KR); Boyoung Kim, Suwon-si (KR); Dongwoo Kim, Suwon-si (KR)

(21) Appl. No.: 19/434,951

(22) Filed: Dec. 29, 2025

Related U.S. Application Data
(63) Continuation of application No. PCT/KR2025/022914, filed on Dec. 26, 2025.

(30) Foreign Application Priority Data
Dec. 27, 2024 (KR) 10-2024-0199243
Jan. 14, 2025 (KR) 10-2025-0005506
Apr. 9, 2025 (KR) 10-2025-0046213

(51) Int. Cl. G06F 3/16; G06F 16/65

(52) U.S. Cl. CPC G06F 3/165; G06F 16/65

(57) ABSTRACT

There is provided an electronic device, method, and non-transitory storage medium for editing audio by receiving a request to edit sound sources included in audio data, determine, using an audio classification module, whether the audio data includes sound sources of types specified by the audio classification module, based on identifying that a first type and a second type are included in the audio data, display, through the display, on a screen for audio editing a first object representing the first type of sound source and the second object representing the second type of sound source, and based on a user input for the first object, control a volume of a first audio, corresponding to the first type of sound source, and the first object and the second object are displayed on the screen before the audio separation module completes separation of the first audio and a second audio

### CROSS-REFERENCE TO RELATED APPLICATIONS

This application is a continuation of International Application PCT/KR2025/022914, filed on Dec. 26, 2025, which is based on and claims priority to Korean Patent Application No. 10-2024-0199243, filed on Dec. 27, 2024, in the Korean Intellectual Property Office, Korean Patent Application No. 10-2025-0005506, filed on Jan. 14, 2025, in the Korean Intellectual Property Office, and Korean Patent Application No. 10-2025-0046213, filed on Apr. 9, 2025, in the Korean Intellectual Property Office, the disclosures of which are incorporated by reference herein in their entireties.

### BACKGROUND

### 1. Field

The disclosure relates to an electronic device, a method, and a non-transitory storage medium for editing audio.

### 2. Description of Related Art

With digital technology advancing, electronic devices come in various types, such as smartphones, tablet personal computers (PCs), or personal digital assistants (PDAs). Electronic devices have been developed to be worn by users so as to enhance portability and user accessibility.

The electronic device may edit each sound source by separating a plurality of sound sources from an audio file including the plurality of sound sources using an audio separation technology. The electronic device separates sound sources from audio data through an audio editing module supporting audio separation technology, stores each of the separated sound sources, and then uses each of the stored sound sources to support editing. This processing method may take a long time to process and store the sound source separation for editing, and since the sound source may be separated only during reproduction, there is no information about separable sound sources until reproduction, which may reduce editing usability.

The above-described information may be provided as related art for the purpose of helping understanding of the disclosure. No claim or determination is made as to whether any of the foregoing is applicable as prior art in relation to the disclosure.

### SUMMARY

There is provided an electronic device including: a display; at least one processor; and memory storing instructions, wherein the instructions, when executed by the at least one processor individually or collectively, cause the electronic device to: receive a request to individually edit each of a plurality of sound sources included in audio data; determine, by an audio classification module, whether the audio data includes sound sources of a plurality of types specified by the audio classification module, the sound sources of the plurality of types being ones of the plurality of sound sources; based on identifying that a first type of sound source and a second type of sound source among the plurality of types are included in the audio data, display, through the display, a screen indicating audio editing of a first object representing the first type of sound source and a second object representing the second type of sound source; and based on a user input to the screen and indicating the first object, control a volume of a first audio corresponding to the first type of sound source and at least partly separated using an audio separation module, wherein the first object and the second object are displayed on the screen before the audio separation module completes separation of the first audio, as corresponding to the first type of sound source, and a second audio, as corresponding to the second type of sound source, in the audio data.

The instructions, when executed by the at least one processor individually or collectively, may further cause the electronic device to: based on identifying that the first type of sound source and the second type of sound source among the plurality of types are included in the audio data, separate, using the audio separation module, the first audio corresponding to the first type of sound source and the second audio corresponding to the second type of sound source in the audio data, and display information, of a time interval in which the first audio is detected, on the screen through the display.

The instructions, when executed by the at least one processor individually or collectively, may further cause the electronic device to: based on both a third type of sound source being determined as not detected among the plurality of types by the audio classification module and also a third audio corresponding to the third type of sound source is determined as at least partly separated using the audio separation module, control a volume of the second audio, corresponding to the second type of sound source, and a volume of the third audio, corresponding to the third type of sound source, based on a user input indicating the second object.

The instructions, when executed by the at least one processor individually or collectively, may further cause the electronic device to: based on determining that a score indicating a detection reliability of the first type of sound source is lower than a specified threshold value, apply, on the screen, a visually distinguishable effect to the first object.

The instructions, when executed by the at least one processor individually or collectively, may further cause the electronic device to: apply a visual effect, on the screen and indicating a controlled volume of the first audio, to the first object, wherein the plurality of types are sound source types classifiable through the audio classification module in the audio data, wherein the audio separation module specifies a number of separable audio types to be lower than a number of types specified by the audio classification module, and wherein the plurality of types includes the sound source types corresponding to the plurality of types.

The instructions, when executed by the at least one processor individually or collectively, may further cause the electronic device to: based on identifying that the third type of sound source is detected among the plurality of types by the audio classification module and identifying that the third type does not correspond to a separable type by the audio separation module, separate the third audio corresponding to the third type into the second type using the audio separation module and control the volume of the third audio based on the user input indicating the second object.

The instructions, when executed by the at least one processor individually or collectively, may further cause the electronic device to: based on identifying that the third type of sound source is a dominant sound source in the audio data, display a third object representing the third type of sound source on the screen through the display; and based on the user input indicating the third object and representing a specific type, control the volume of the third audio corresponding to the third type of sound source.

The instructions, when executed by the at least one processor individually or collectively, may further cause the electronic device to: display waveform information on the sound sources as separable from the audio data on the screen through the display.

The instructions, when executed by the at least one processor individually or collectively, may further cause the electronic device to: determine whether the sound sources of the plurality of types specified by the audio classification module are included in a sampled interval from the audio data through the audio classification module.

There is provided a method for operating an electronic device, the method including: receiving a request to individually edit each of a plurality of sound sources included in audio data; determining, by an audio classification module, whether the audio data includes sound sources of a plurality of types specified by the audio classification module, the sound sources of the plurality of types being ones of the plurality of sound sources; based on identifying that a first type of sound source and a second type of sound source among the plurality of types are included in the audio data, displaying, through a display of the electronic device, a screen indicating audio editing of a first object representing the first type of sound source and a second object representing the second type of sound source; and based on a user input to the screen and indicating the first object, controlling a volume of a first audio corresponding to the first type of sound source and at least partly separated using an audio separation module, wherein the first object and the second object are displayed on the screen before the audio separation module completes separation of the first audio, as corresponding to the first type of sound source, and a second audio, as corresponding to the second type of sound source, in the audio data.

The method may further include: based on identifying that the first type of sound source and the second type of sound source among the plurality of types are included in the audio data, separating, using the audio separation module, the first audio corresponding to the first type of sound source and the second audio corresponding to the second type of sound source in the audio data; and displaying information of a time interval in which the first audio is detected on the screen through the display.

The method may further include: based on both a third type of sound source being determined as not detected among the plurality of types by the audio classification module and also a third audio corresponding to the third type of sound source being determined as at least partly separated using the audio separation module, controlling a volume of the second audio corresponding to the second type of sound source and a volume of the third audio, corresponding to the third type of sound source, based on a user input indicating the second object.

The method may further include: based on determining that a score indicating a detection reliability of the first type of sound source is lower than a specified threshold value, applying, on the screen, a visually distinguishable effect to the first object.

The method may further include: applying a visual effect, on the screen and indicating a controlled volume of the first audio, to the first object.

The method may further include: wherein the plurality of types are sound source types classifiable through the audio classification module in the audio data, wherein the audio separation module specifies a number of separable audio types to be lower than a number of types specified by the audio classification module, and wherein the plurality of types includes the sound source types corresponding to the plurality of types.

The method may further include: based on identifying that the third type of sound source is detected among the plurality of types by the audio classification module, and identifying that the third type does not correspond to a separable type by the audio separation module, separating the third audio corresponding to the third type into the second type using the audio separation module and controlling the volume of the third audio based on the user input indicating the second object.

The method may further include: based on identifying that the third type of sound source is a dominant sound source in the audio data, displaying a third object representing the third type of sound source on the screen through the display; and based on the user input indicating the third object and representing a specific type, controlling the volume of the third audio corresponding to the third type of sound source.

The method may further include: displaying waveform information on the sound sources as separable from the audio data on the screen through the display.

The method may further include: determining whether the sound sources of the plurality of types specified by the audio classification module are included in a sampled interval from the audio data through the audio classification module.

There is provided a non-transitory storage medium storing one or more programs including instructions configured to, when executed by at least one processor of an electronic device, cause the electronic device to: receive a request to individually edit each of a plurality of sound sources included in audio data; determine, by an audio classification module, whether the audio data includes sound sources of a plurality of types specified by the audio classification module, the sound sources of the plurality of types being ones of the plurality of source sources; based on identifying that a first type of sound source and a second type of sound source among the plurality of types are included in the audio data, display, through a display of the electronic device, a screen indicating audio editing of a first object representing the first type of sound source and a second object representing the second type of sound source; and based on a user input to the screen and indicating the first object, control a volume of a first audio corresponding to the first type of sound source and at least partly separated using an audio separation module, wherein the first object and the second object are displayed on the screen before the audio separation module completes separation of the first audio, as corresponding to the first type of sound source, and a second audio, as corresponding to the second type of sound source, in the audio data.

### BRIEF DESCRIPTION OF THE DRAWINGS

The above and other aspects, features, and advantages of specific embodiments of the present disclosure will be more apparent from the following description with reference to the accompanying drawings, in which:

FIG. 1 is a view illustrating an electronic device in a network environment according to various embodiments;

FIGS. 2A and 2B are views illustrating a configuration example for audio editing of an electronic device according to one or more embodiments;

FIG. 3 is a view illustrating an example for audio classification of an electronic device according to one or more embodiments;

FIGS. 4A and 4B are views illustrating an example for audio separation and editing of an electronic device according to one or more embodiments;

FIGS. 5A, 5B, and 5C are views illustrating an example of a screen for audio editing in an electronic device according to one or more embodiments;

FIG. 6 is a view illustrating an example for audio separation and editing of an electronic device according to one or more embodiments;

FIG. 7A is a view illustrating an example of selecting a plurality of audio classification modules in an electronic device according to one or more embodiments;

FIG. 7B is a view illustrating an example of selecting a plurality of audio separation modules in an electronic device according to one or more embodiments;

FIG. 7C is a view illustrating an example of selecting a plurality of audio classification modules and a plurality of audio separation modules in an electronic device according to one or more embodiments;

FIG. 8 is a view illustrating an example of an operation method in an electronic device according to one or more embodiments;

FIG. 9 is a view illustrating an example of an operation method in an electronic device according to one or more embodiments; and

FIG. 10 is a view illustrating an example of a screen for editing audio separated from audio data in an electronic device according to one or more embodiments.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions. As used herein, the term “user” may denote a human or another device (e.g., an artificial intelligent electronic device) using the electronic device.

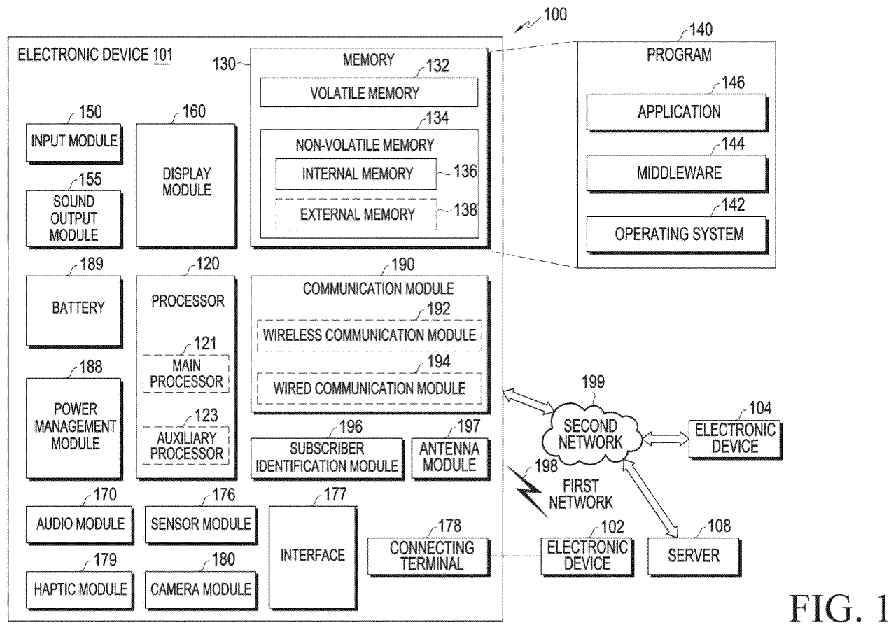

FIG. 1 is a block diagram illustrating an electronic device 101 in a network environment 100 according to various embodiments.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

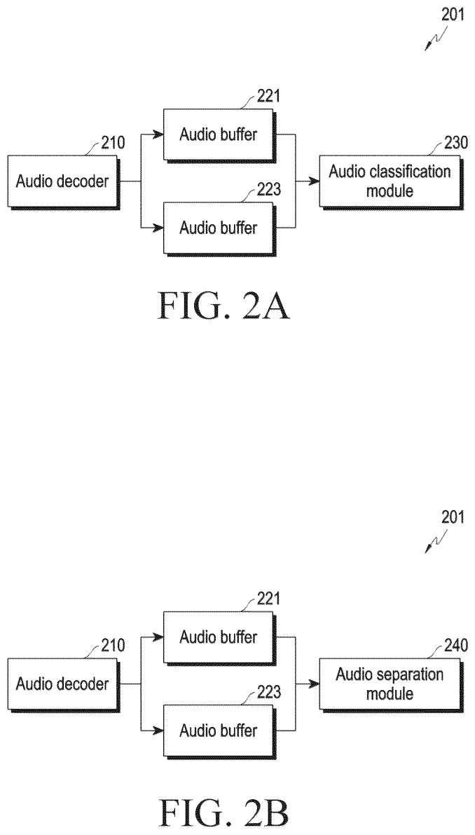

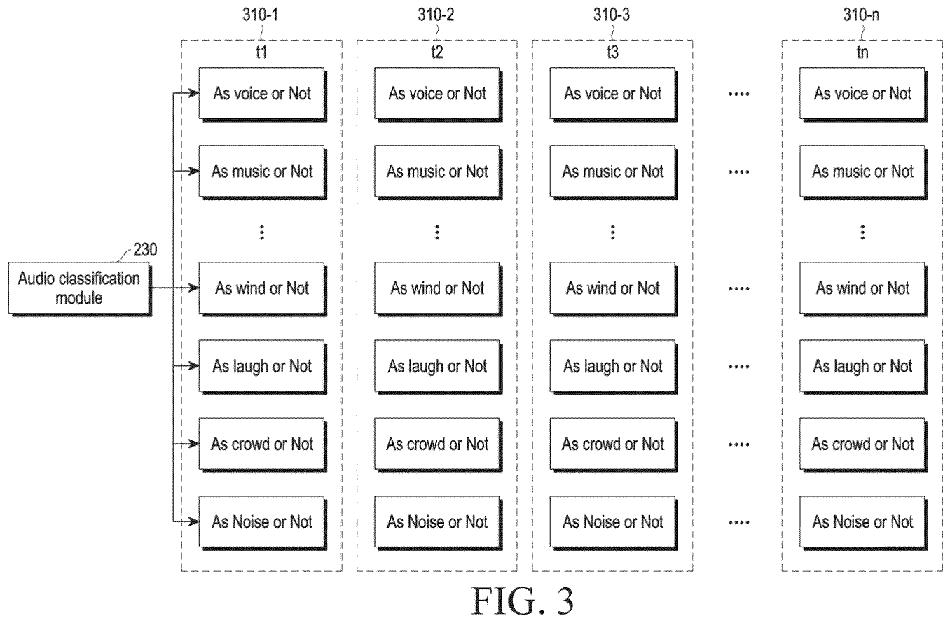

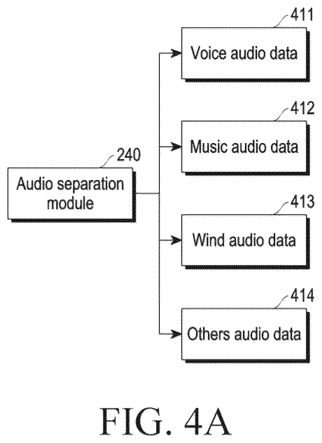

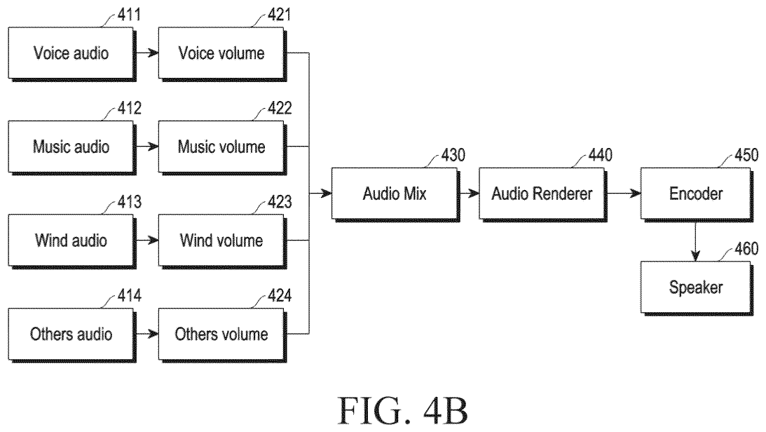

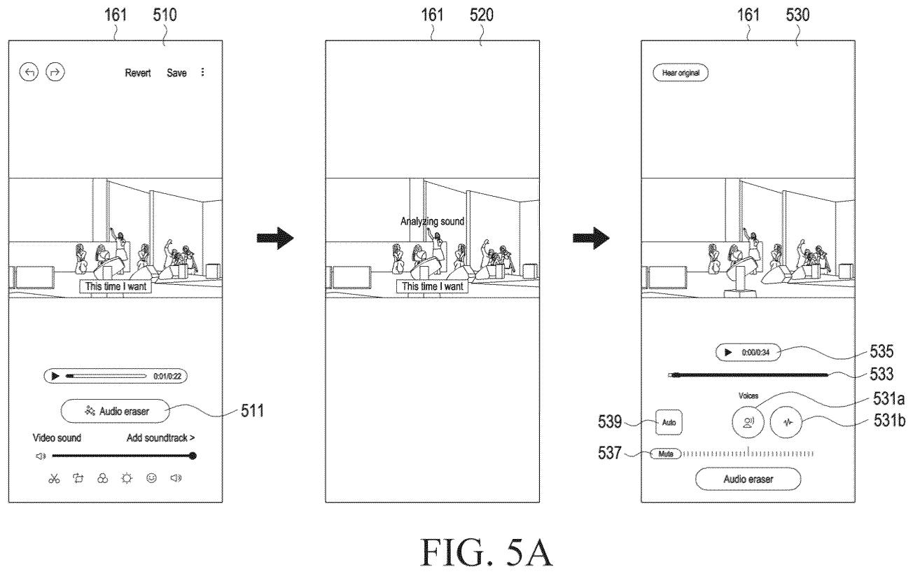

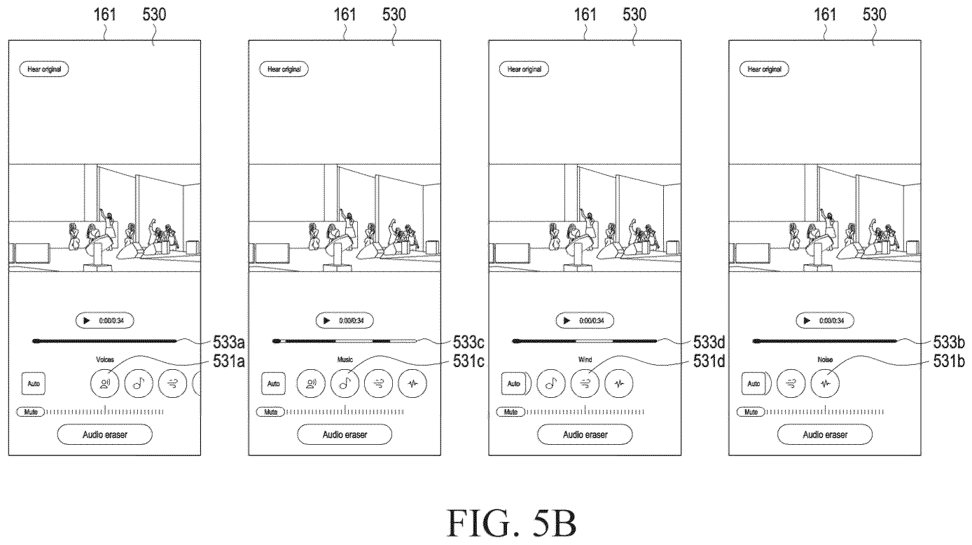

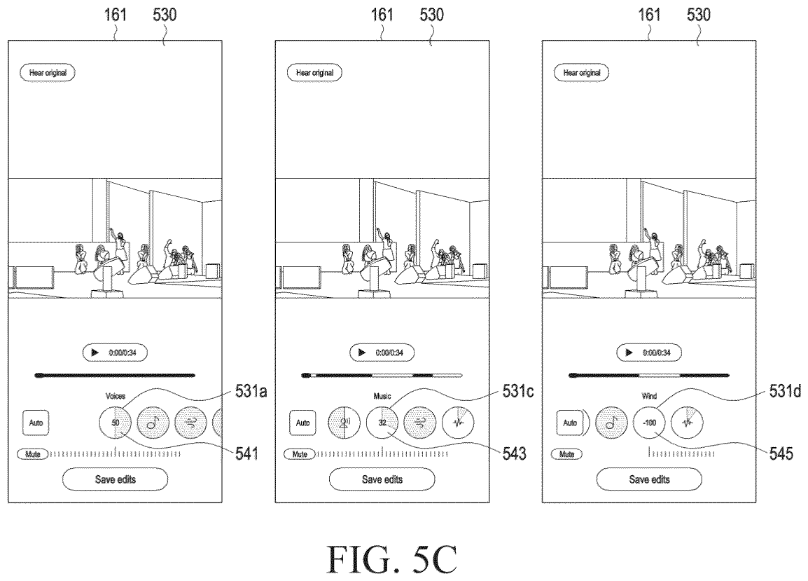

FIGS. 2A and 2B are views illustrating a configuration example for audio editing of an electronic device according to one or more embodiments, FIG. 3 is a view illustrating an example for audio classification of an electronic device according to one or more embodiments, FIGS. 4A and 4B are views illustrating an example for audio separation and editing of an electronic device according to one or more embodiments, and FIGS. 5A, 5B, and 5C are views illustrating an example of a screen for audio editing in an electronic device according to one or more embodiments.

Referring to FIGS. 1, 2A, 2B, 3, 4A, 4B, 5A, 5B, and 5C, the electronic device 101 (e.g., the electronic device 101 of FIG. 1) according to one or more embodiments may include at least one processor (e.g., the processor 120), memory (e.g., the memory 130 of FIG. 1), a display (e.g., the display module 160 of FIG. 1), an audio circuit (e.g., the audio module 170 of FIG. 1), a communication circuit (e.g., the communication module 190 of FIG. 1), and a speaker (e.g., the sound output module 155 of FIG. 1). The disclosure is not limited thereto, and the electronic device 101 may be implemented in the same or similar manner as the electronic device 101 of FIG. 1, and may further include other components of the electronic device 101 of FIG. 1. Further, the electronic device 101 may be configured to further include other components necessary for the operation method of the disclosure. According to one or more embodiments, the electronic device 101 may be a device in the form of an on-device that stores an artificial intelligence model in the memory 130. According to one or more embodiments, the electronic device 101 may perform audio editing using an audio separation function (e.g., a solution or program) and an audio classification function. Here, the audio separation function and the audio classification function may cause inconsistency of the processed information due to the difference in performance. The audio classification function may be a function with a higher processing speed than the audio separation function.

According to one or more embodiments, the electronic device 101 may include an audio editing module 201 including an audio classification module 230 (e.g., an audio classifier) for processing an audio classification function and an audio separation module 240 (e.g., an audio separator) for processing an audio separation function. For example, the audio editing module 201 is a module (e.g., function, application, or program) included in the memory 130, and may further include other modules (e.g., functions or programs) necessary for audio editing in addition to the audio classification module 230 and the audio separation module 240.

According to one or more embodiments, the processor 120 of the electronic device 101 may edit the audio data input for editing through audio buffers 221 and 223 through an audio decoder 210 using the audio classification module 230 and the audio separation module 240. According to one or more embodiments, the electronic device may obtain the type and interval information about all separable sound sources as the audio data output from the audio decoder 210 is entirely output and is transferred as an input to the audio classification module 230 or may obtain audio information about the corresponding audio data through the audio classification module 240 as it is partially output and stored in the audio buffer.

According to one or more embodiments, the processor 120 may repeat at a designated time interval t using the audio classification module 230 to identify (at each of intervals 310-1, 310-2, 310-3, . . . , 310n) whether a sound source is detected (e.g., present) for each of the first sound source types for each entire time interval t1 to tn of audio data, and store the detected sound source information (e.g., the type of detected sound source) and interval information for a designated time interval in the memory 130 according to the identification result. According to one or more embodiments, when detecting at least one sound source respectively corresponding to at least one type from the audio data, the processor 120 may identify the probability value (e.g., a score indicating the detection reliability) that each of the detected at least one sound source is to be present and, if the identified probability value is larger than a threshold, identify that the sound source is detected (e.g., included in the audio data). When the identified probability value is smaller than or equal to the threshold, the processor 120 may detect it as noise. The plurality of types designated to be classified (e.g., detected) in the audio classification module 230 are sound source types that may be independently detected by a designated number according to the performance of the audio classification module 230, and may include at least one of voice, music, wind, noise, laugh, and/or crowd, and may include noise as other types. The sound source type is not limited thereto, and may be designated by being replaced with, or adding other types of sound sources.

FIGS. 4A and 4B are views illustrating an example for audio separation and editing of an electronic device according to one or more embodiments.

Referring to FIGS. 4A and 4B, the processor 120 of the electronic device 101 according to one or more embodiments may separate audio data reproduced using the audio separation module 240. The plurality of types separable from the audio separation module 240 may be designated according to the performance of the audio separation module 240, and may include, e.g., voice 411 (voice audio data), music 412 (music audio data), wind audio data, and/or other types 414 (other audio data). Examples of sound source types are not limited thereto, and may be designated by being replaced with, or adding other types of sound sources. In the audio separation module 240, the type and number of audios (e.g., sound sources) separated due to the difference in performance of the audio classification module 230 may not match the type and number of sound sources detected by the audio classification module 230. For example, the audio separation module 240 may designate a sound source type (e.g., an audio type) that may be separated by a smaller number than the number of sound source types designated by the audio classification module 230. According to one or more embodiments, the processor 120 may separate audios from the entire audio data through the audio separation module 240 at designated time intervals (e.g., 2 seconds). According to one or more embodiments, the audio separation module 240 may output audios separated from audio data through audio channels of designated sound source types (e.g., audio types) regardless of the presence or absence of a separated result and, if there is no separated result, may be output as 0. Here, the rest of the data except for the sound source separable from the audio data may be separated and output as other audio data. The disclosure is not limited thereto, and the result of the audio separation module 240 may be changed. For example, the audio separation module 240 may separate and output only separable audios identified in the audio data based on information about separable sound sources identified in the audio classification module 230, and provide a function for controlling or editing separated audio. In order to separate audios from the audio data based on the information about the separable sound source identified by the audio classification module 230, the electronic device 101 may process the model information used by the audio separation module 240 differently at necessary times.

According to one or more embodiments, the processor 120 may mix separated audios reflecting the editing result through the audio mixer 430 and then output the mixed audio data through the speaker 460 via the audio renderer 440 and the encoder 450.

FIGS. 5A, 5B, and 5C are views illustrating an example of a screen for audio editing in an electronic device according to one or more embodiments.

Referring to FIG. 5A, according to one or more embodiments, when the processor 120 receives an execution request for an audio editing function (e.g., an application related to audio editing), the processor 120 may display an execution screen 510 for audio editing on the display 161 and identify the audio data to be edited. When the editing menu 511 (e.g., a button or an object) included in the execution screen 510 is selected (e.g., when a request for individually editing each of the plurality of sound sources included in the audio data is received), the processor 120 may identify whether a plurality of types of sound sources are included in the audio data through the audio classification module 230. Sound source information according to the identification result and information about the time interval for identifying whether a plurality of types of sound sources are included may be stored in the memory 130. According to one or more embodiments, when receiving a selection input for the edit menu 511 (e.g., a button or an object) included in the execution screen 510, the processor 120 may display a screen 520 for audio classification processing while obtaining information about the separable sound source through the audio classification module 230 before reproducing audio data.

According to one or more embodiments, the processor 210 may display a first screen 530 for separating and editing audio data through the audio separation module 240 when reproducing audio data based on the information about the sound source detected by the audio classification module 230 and information about the time interval. According to one or more embodiments, when receiving an input of an audio editing button (e.g., an audio eraser button) included in the execution screen 510, the processor 210 may obtain information about the time interval when a first sound source (e.g., voice) is detected from the audio data based on identifying the first sound source (e.g., voice) of the first type (e.g., voice type) among the plurality of types from the audio data through the audio classification module 230, and may display, on the display 161, a first object 531a representing the first sound source of the first type (e.g., one of the plurality of types) and a second object 531b representing the other type in a specific time interval (e.g., one of the intervals t1 to tn) while reproducing the audio data. Here, the other type may be referred to as noise, but is not limited thereto, and may be referred to as others or by a name designated by the user. For example, the processor 120 may further display, on the first screen 530, objects representing other types of sound sources on the first screen 530 in addition to the first object 531a representing the first type of first sound source and the second object 531b representing the other type (e.g., noise) to edit the sound sources separated by the audio separation module 240. For example, the objects 531a, 531b, 531c, and/or 531d representing the types of voice, noise, music, and/or wind, respectively, may be displayed on the first screen 530, as illustrated in FIG. 5B. As illustrated in FIG. 5A, the first screen 530 may include 533 information about the time interval, information 535 about the audio data reproduction time, an object 537 for adjusting the volume, and/or an automatic editing button 539.

Referring to FIG. 5B, according to one or more embodiments, the processor 120 may pre-identify the types of sound sources for audios that may be separated for each time interval from the entire audio data based on the information about the sound source and the information about the time interval, so objects representing the types of sound sources corresponding to audios separable from the audio data may be displayed on the first screen 530. For example, if it is identified that sound source types for voice, music, wind, and/or noise among the plurality of types are detected from the audio data in the time interval using the audio classification module 230, the processor 120 may display objects 531a, 531b, 531c, and/or 531d respectively representing voice, music, wind, and/or other types for the detected sound sources on the first screen 530 for editing when reproducing audio data. The processor 120 may display information 533a, 533b, 533c, and/or 533d about the time interval. According to one or more embodiments, when the information about the separable sound sources identified (e.g., detected) identified (e.g., detected) in the audio classification module 230 is the same as information about separable audios (e.g., audios channels) provided by the audio separation module 240, the processor 120 may provide an object (e.g., editing UI) for controlling or editing each separable sound source on the first screen 530, thereby enabling 1:1 mapping control and editing through the audios (e.g., audio channels) separated through audio separation.

According to one or more embodiments, the processor 120 may perform editing (e.g., volume control) on the audio separated from the audio data corresponding to the detected sound source corresponding to the selected object based on a user input of selecting one of the first objects 531a, 531b, 531c, and 531d displayed on the first screen 530. The processor 120 may apply a visual effect corresponding to a result of editing (e.g., volume control) to the selected object. According to one or more embodiments, the processor 120 may apply a visual effect (e.g., a volume control number and a graph) indicating a result of volume control to the objects 531a, 531b, 531c, and 531d representing the sound sources.

According to one or more embodiments, when the second sound source of the second type (e.g., music type) is not detected in the first time interval among the plurality of types by the audio classification module 230, and the second audio of the second type is separated and not consistent using the audio separation module 240, the processor 120 does not display the object 531c corresponding to the second type for volume control of the second audio of the second type, and maps the second audio of the second type to the noise channel and, when receiving a user input for the second object 531b, may control the volume of the second audio and the third audio corresponding to the sound source of the other type (e.g., the second type). According to one or more embodiments, the processor 120 may obtain information about the separable sound source identified through the audio classification module 230 before starting audio editing from the memory 130 or an external electronic device (e.g., cloud) to enhance editing usability by reducing the waiting time before audio editing through the audio classification module 230 having a faster processing time than the audio separation module 240. When the obtained information about the separable sound source is the same as the audio separable by the audio separation module 240, the processor 120 may control/edit the output of the audio separation module 240 based on the obtained information about the separable sound source. For example, if the information about the separable sound source obtained from the audio does not correspond to the separable audio provided by the audio separation module 240, it may be determined whether the corresponding information is separated into noise and matched to the other audio data of the audio separation module 240 to be controlled/edited, and the control/editing function may be provided.

According to one or more embodiments, if the third sound source of the third type (e.g., the laugh type) detected in the first time interval among the plurality of types is detected by the audio classification module 230, and the third type does not correspond to the types of sound sources separable from the audio separation module 240, the processor 120 may separate the third sound source into noise using the audio separation module and control the volume of the fourth audio corresponding to the third sound source together with the third audio corresponding to noise based on the user input for the second object representing the noise. Since the sound sources separable from the audio separation module 240 are audio data necessary for audio editing, the processor 120 may provide objects for control or editing respectively corresponding to the separable sound sources on the screen for editing and, since the other audio data, which is the sound source other than the separable sound sources, is separated as noise, the processor 120 may provide an object for noise on the screen.

According to one or more embodiments, when the processor 120 identifies that the third sound source of the third type is not separated by the audio separation module 240 and is a dominant sound source in the audio data, the processor 120 may display the third object representing the third sound source on the display 161. According to one or more embodiments, the processor 120 may individually control the volume of the fourth audio corresponding to the third sound source based on a user input for the third object. For example, only the sound made by the dog is detected by the audio classification module 230, and information about the sound made by the dog may be displayed on the second object 531b representing the noise of the audio separation module 240.

According to one or more embodiments, when the types of the separable sound sources identified by the audio classification module 230 are fewer than the sound source types separable by the audio separation module 240, a UI is necessary for controlling the sound source not detected during audio separation. Thus, since the separable sound source not detected during audio classification is significantly less likely to be separated and output during audio separation, an object corresponding to a specific UI or noise UI for controlling the audio channel of the sound source not detected during audio separation may be displayed on the first screen 530 for editing. For example, since the probability of the first sound source being present in the audio is very low when the first sound source (e.g., voice) is not detected, the processor 120 may display the audio separation voice channel as an object representing noise on the first screen for editing. The processor 120 may indicate UI-wise that separability is low by applying a different color or icon to the separable sound source not detected during audio separation. For example, when the first sound source (e.g., voice) is not detected (e.g., when the score representing the detection reliability of the first sound source is lower than a designated threshold), the processor 120 may apply a visually differentiated effect to the first object (e.g., the object 531a representing voice) representing the first sound source, indicating that the probability of the first sound source being detected is low.

Referring to FIG. 5C, according to one or more embodiments, the processor 120 may apply a visual effect to, and display, a control result (or an editing result) of performing the control/editing function on the output of the audio separation module 240 based on the information about the separable sound source obtained. For example, a visual effect 541 (e.g., a number and/or graph) representing a control result according to the volume control of the first audio for the first sound source (e.g., voice) may be applied to the first object 531a. For example, a visual effect 543 (e.g., a number and/or graph) representing a control result according to the volume control of the first audio for the second sound source (e.g., music) may be applied to the first object 531c. For example, a visual effect 545 (e.g., a number and/or graph) representing a control result according to the volume control of the first audio for the third sound source (e.g., wind) may be applied to the first object 531d.

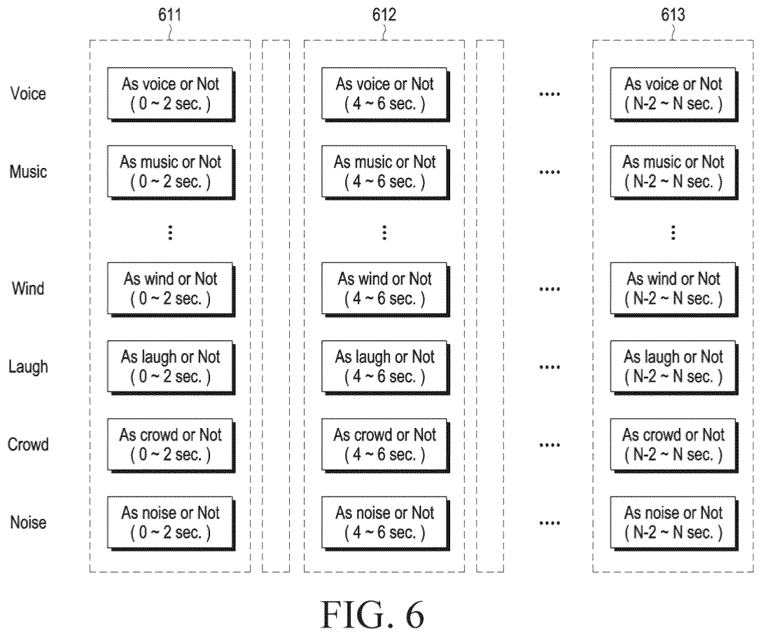

FIG. 6 is a view illustrating an example for audio separation and editing of an electronic device according to one or more embodiments. Referring to FIG. 6, according to one or more embodiments, the processor 120 of the electronic device 101 may sample the entire audio data by the audio classification module 230 to obtain information and interval information about sound sources detected in the sampling interval 611, 612, and/or 613, in order to prevent the waiting time before editing from increasing as the processing time increases when the length of the audio data is longer than a designated length. The processor 120 may reduce the waiting time before editing based on the information about sound sources and interval information detected in the sampling interval 611, 612, and/or 613. When the processor 120 performs audio classification through the audio classification module 230 using only a portion of the audio rather than the entire audio through sampling, the processor 120 may perform audio control/editing based on the sampling ratio (e.g., probability) for the portion of the audio so as not to miss information about separable sound sources that may be present in the portion of the audio. When performing audio control/editing based on the sampling rate (e.g., probability) for a portion of audio, if it is a reference value or less, the processor 120 may display a screen for editing (e.g., the first screen 530 of FIGS. 5A, 5B, and 5C) including objects (e.g., editing UI) corresponding to all of the separated sound sources output from the audio separation module 240 instead of including objects corresponding to sound sources separated based on the information about the sound source separable from the audio classification module 240. The processor 120 may display an object (e.g., a visual effect of displaying a different color on an icon or an object of the corresponding sound source) on the screen for editing (e.g., the first screen 530 of FIGS. 5A, 5B, and 5C) indicating that information about sound sources detected by the audio classification module 230 may be stochastically less reliable.

According to one or more embodiments, when the information about the time interval identified by the audio classification module 230 is different from the interval information identified by the audio separation module 240, the processor 120 may change the information about the different time intervals, display the changed (e.g., updated) interval information, and display a visual effect or object indicating that the interval information is different on the first screen.

According to one or more embodiments, when selecting an option when reproducing audio data, the processor 210 may additionally display an audio waveform separated through the audio separation module 240 on the first screen. Here, the audio waveform may be an audio waveform for the corresponding time interval based on the interval information, and may include an audio waveform of the time axis and/or an audio waveform of the frequency axis.

According to the disclosure, the electronic device may address the issue that different results are obtained for separable sound sources due to different solutions when editing sound sources separated during audio separation through the audio separation module 240 using the result information of the audio classification module 230. For example, when the sound source for voice is separated and output during audio separation although voice information is not detected during audio classification, separable sound source information is provided only with the audio classification result information and, when only editing of the corresponding information is allowed, the incapability of controlling the audio data separated and output through actual audio separation may be addressed. When voice is not detected from the audio classification result, if the object corresponding to voice is not exposed, the corresponding audio data cannot be edited when voice output is generated through audio separation, thereby addressing the incapability of controlling all audio data separated and output to the user. For example, the electronic device may prevent the error in which the sound for voice is output despite changing the volume of the audio editing UI shown to the user to 0.

According to one or more embodiments, the processor 120 may show all sound source information separable in the corresponding audio data or only dominant sound source information for the results of applying one or more audio classification modules 230. Further, the processor 120 may provide a UI for the user to select the audio classification module 230 capable of detecting specific sound sources and, after obtaining the corresponding information from the audio classification module 230, apply the audio separation module 240 capable of separating the corresponding sound sources and provide editing to the user.

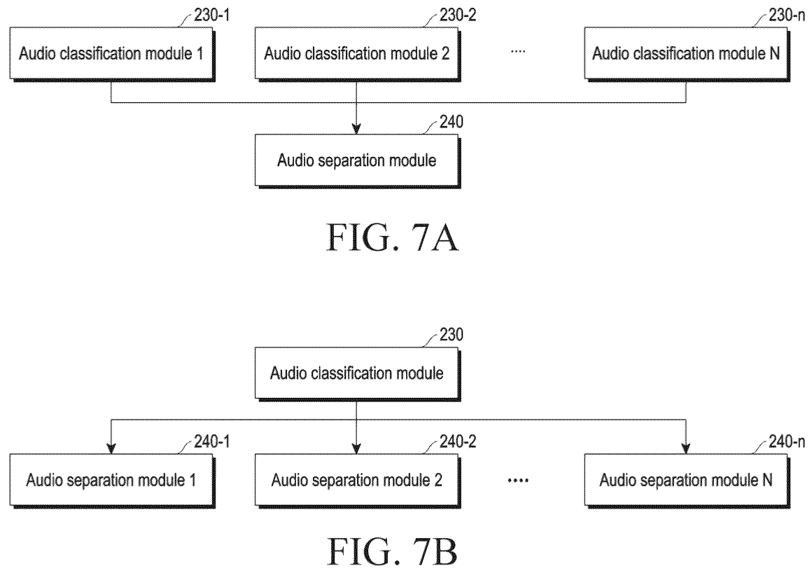

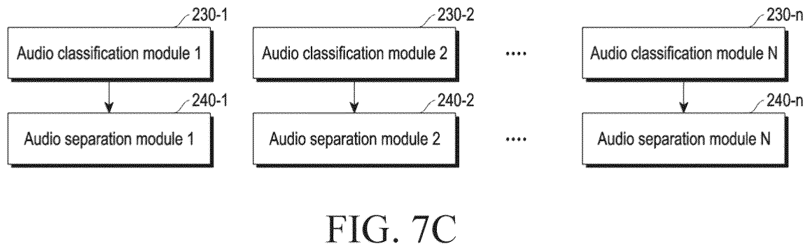

FIG. 7A is a view illustrating an example of selecting a plurality of audio classification modules in an electronic device according to one or more embodiments.

Referring to FIG. 7A, according to one or more embodiments, when there are a plurality of audio classification modules 230, the electronic device 101 may display a screen (e.g., UI or object) for selecting an audio classification module to perform detection (e.g., identify the presence) on a specific sound source among the plurality of audio classification modules 230-1, 230-2, . . . , 230-n. The electronic device 101 may select the audio classification module (e.g., the second audio classification module 230-2) for identifying whether a specific sound source is detected among the plurality of audio classification modules 230-1, 230-2, . . . , 230-n through the screen. The type of sound source to be detected may be designated for each of the plurality of audio classification modules 230-1, 230-2, . . . , 230-n. According to one or more embodiments, to prevent such an occasion where it is impossible to control or edit audio as detection is not performed during audio classification and the editing UI for the sound source separated during audio separation is not exposed to the user, the electronic device 101 may separate all sound sources not detected by the audio classification module 230 in the audio data into the other type (e.g., noise) by the audio separation module 240 and display an object (e.g., editing UI) corresponding to the other type (e.g., noise) on the screen for editing (e.g., the first screen 530 of FIGS. 5A, 5B, and 5C) to control or edit all sound sources not detected.

FIG. 7B is a view illustrating an example of selecting a plurality of audio separation modules in an electronic device according to one or more embodiments.

Referring to FIG. 7B, according to one or more embodiments, when there are a plurality of audio separation modules 240, the electronic device 101 may select an audio separation module (e.g., the second audio separation module 240-2) capable of separating specific sound sources among the plurality of audio separation modules 240-1, 240-2, . . . , 240-n, separate sound sources, and configure and display a first screen for editing. Each of the plurality of audio separation modules 240-1, 240-2, . . . , 240-n may process designated audio channels (e.g., second sound sources) or designate and process the sub channels (e.g., sub sound source types) of the audio channels, respectively. For example, if sub channels are included in the audio channel corresponding to music, the second audio separation module 1 240-1 may process the first sub channel e.g., piano, the second audio separation module 2 240-2 may process the second sub channel e.g., guitar, and the nth audio separation module 240-n may process the nth sub channel e.g., drum. According to one or more embodiments, when the audio applied to the audio classification module 230 is sampled and applied at a predetermined ratio or more to enhance processing time, the electronic device 101 may display, on the screen for editing (e.g., the first screen 530 of FIGS. 5A, 5B, and 5C), objects (e.g., editing UI) for all sound sources separable during audio separation although there is a sound source not included in the sampled audio data not to miss information about separable sound sources that may be present in a portion of the audio. Thus, the electronic device may address the incapability of accurate information transfer for separated sound sources included in audio when the reliability of the result is reduced by performing sampling a number of times more than a specific threshold as the reliability for separable sound source information included in the entire audio is low using only the audio classification result.

FIG. 7C is a view illustrating an example of selecting a plurality of audio classification modules and a plurality of audio separation modules in an electronic device according to one or more embodiments.

Referring to FIG. 7C, according to one or more embodiments, when there are a plurality of audio classification modules 230 and there are a plurality of audio separation modules 240, the electronic device may select an audio separation module (e.g., the first audio separation module 240-1) from among the plurality of audio separation modules 240-1, 240-2, . . . , 240-n capable of separating a specific sound source detected from an audio separation module (e.g., the first audio classification module 230-1) selected from among the plurality of audio classification modules 230-1, 230-2, . . . , 230-n, separate sound sources, and configure and display a first screen for editing. When there are two or more selected audio classification modules, two or more audio separation modules may be selected. For example, the audio separation module capable of separating separable sound sources for each audio classification module 230 may be determined in advance.

According to one or more embodiments, the processor 120 is a hardware module or a software module (e.g., an application program), and may be a hardware component (function) or a software component (program) including at least one component provided in the electronic device 101. According to one or more embodiments, the processor 120 may include, e.g., a hardware module, a software module, a firmware module, or a combination of two or more thereof. The processor 120 may lack at least some of the components or may include other components for performing an image processing operation in addition to the components.

The electronic device (e.g., the electronic device 101 of FIG. 1) according to one or more embodiments may implement a software module (e.g., the program 140 of FIG. 1) related to audio editing. The memory (e.g., the memory 130 of FIG. 1) of the electronic device may store commands (e.g., instructions) for implementing the software module. The at least one processor (e.g., the processor 120 of FIG. 1) may execute instructions stored in the memory to implement the software module, and may control hardware (e.g., the sensor module 176 of FIG. 1, the camera module 180, the communication module 190 of FIG. 1, and the display module 160 of FIG. 1) associated with the function of the software module.

According to one or more embodiments, the software module of the electronic device 101 may include a kernel (or hardware abstraction layer (HAL)), a framework (e.g., the middleware 144 of FIG. 1) and an application (e.g., the application 146 of FIG. 1). At least part of the program module may be preloaded on the electronic device 101 or may be downloaded from a server (e.g., the server 108).

According to one or more embodiments, the kernel may include, e.g., a system resource manager or a device driver, but is not limited thereto and may be configured to further include other modules. The system resource manager may perform control, allocation, or recovery of system resources. The device driver may include, e.g., a display driver, a camera driver, a Bluetooth driver, a shared memory driver, a USB driver, a keypad driver, a Wi-Fi driver, an audio driver, or an inter-process communication (IPC) driver.

According to one or more embodiments, the framework may provide functions commonly required by the application, or may provide various functions to the application through an application programming interface (API) such that the application may efficiently use limited system resources inside the electronic device 101. The framework may include a module that forms a combination of various functions of the components. The framework may provide a specified module per type of the operating system in order to provide a differentiated function. The framework may dynamically omit some existing components or add new components.

According to one or more embodiments, the application may be configured to include an application (e.g., a module, a manager, or a program) for editing audio. The application may include an application received from an external electronic device (e.g., the server 108 or the electronic devices 102 and 104). According to one or more embodiments, the application may include a preloaded application or a third party application downloadable from a server. The components of the software module and the names of the components according to the illustrated embodiment may be varied depending on the type of the operating system. According to one or more embodiments, at least a part of the software module may be implemented in software, firmware, hardware, or in a combination of two or more thereof. At least part of the software module may be implemented (e.g., executed) by e.g., a processor (e.g., an application processor (AP)). At least a part of the software module may include at least one of, e.g., a module, program, routine, set of instructions, process, or the like for performing at least function.

Main components of the electronic device 101 of FIG. 1 have been described above according to one or more embodiments. According to one or more embodiments; however, all of the components of FIG. 1 are not essential components, and the electronic device 101 may be implemented with more or less components than those shown. The positions of the major components of the electronic device 101 described above in connection with FIG. 1 may be varied according to various embodiments of the disclosure.

According to one or more embodiments, an electronic device (e.g., the electronic device 101 of FIG. 1) may comprise a display (e.g., the display module 160 of FIG. 1, the display 161 of FIGS. 5A, 5B, and 5C), at least one processor (e.g., the processor 120 of FIG. 1) including a processing circuit, and memory (e.g., the memory 130 of FIG. 1) storing instructions.

According to one or more embodiments, the instructions may, when executed by the at least one processor individually or collectively, cause the electronic device to receive a request to individually edit each of a plurality of sound sources included in audio data.

According to one or more embodiments, the instructions may, when executed by the at least one processor individually or collectively, cause the electronic device to determine, using an audio classification module (e.g., the audio classification module 230 of FIG. 2A), whether the audio data includes sound sources of a plurality of types specified by the audio classification module.

According to one or more embodiments, the instructions may, when executed by the at least one processor individually or collectively, cause the electronic device to, based on identifying that a first type of sound source and a second type of sound source among the plurality of types are included in the audio data, display, through the display, on a screen for audio editing a first object representing the first type of sound source and the second object representing the second type of sound source.

According to one or more embodiments, the instructions may, when executed by the at least one processor individually or collectively, cause the electronic device to, based on a user input for the first object, control a volume of a first audio, corresponding to the first type of sound source, separated using an audio separation module 240.

According to one or more embodiments, the first object and the second object may be displayed on the screen for audio editing before the audio separation module completes separation of the first audio corresponding to the first type of sound source and a second audio corresponding to the second type of sound source in the audio data.

According to one or more embodiments, the instructions may, when executed by the at least one processor individually or collectively, cause the electronic device to, based on identifying that a first type of sound source and a second type of sound source among the plurality of types are included in the audio data, separate, using the audio separation module, the first audio corresponding to the first type of sound source and the second audio corresponding to the second type of sound source in the audio data.

According to one or more embodiments, the instructions may, when executed by the at least one processor individually or collectively, cause the electronic device to display information of a time interval in which the first audio is detected on the screen through the display.

According to one or more embodiments, the instructions may, when executed by the at least one processor individually or collectively, cause the electronic device to, based on determining that a third type of sound source is not detected among the plurality of types by the audio classification module, and a third audio corresponding to the third type of sound source is separated using the audio separation module, control a volume of the second audio corresponding to the second type of sound source and a volume of the third audio corresponding to the third type of sound source based on a user input for the second object.

According to one or more embodiments, the instructions may, when executed by the at least one processor individually or collectively, cause the electronic device to, based on determining that a score indicating a detection reliability of the first type of sound source is lower than a specified threshold value, apply, on the screen, a visually distinguishable effect to the first object.

According to one or more embodiments, the instructions may, when executed by the at least one processor individually or collectively, cause the electronic device to apply a visual effect indicating the controlled volume of the first audio to the first object.

According to one or more embodiments, the plurality of types may be a sound source type classifiable through the audio classification module in the audio data.

According to one or more embodiments, the audio separation module may specify the number of separable audio types to be lower than the number of types specified by the audio classification module, and the plurality of types may include sound source types corresponding to the plurality of audio types.

According to one or more embodiments, the instructions may, when executed by the at least one processor individually or collectively, cause the electronic device to, based on identifying that the third type of sound source is detected among the plurality of types by the audio classification module, and identifying that the third type does not correspond to a separable type by the audio separation module, separate a third audio corresponding to the third type into the second type using the audio separation module and control a volume of the third audio based on a user input for the second object.

According to one or more embodiments, the instructions may, when executed by the at least one processor individually or collectively, cause the electronic device to, based on identifying that the third type of sound source is a dominant sound source in the audio data, display a third object representing the third type of sound source on the screen through the display, and based on the user input for the object representing the specific type, control the volume of the third audio corresponding to the third type of sound source.

According to one or more embodiments, the instructions may, when executed by the at least one processor individually or collectively, cause the electronic device to display waveform information on sound sources separable from the audio data on the screen through the display.

According to one or more embodiments, the instructions may, when executed by the at least one processor individually or collectively, cause the electronic device to determine whether the sound sources of the plurality of types specified by the audio classification module are included in a sampled interval from the audio data through the audio classification module.

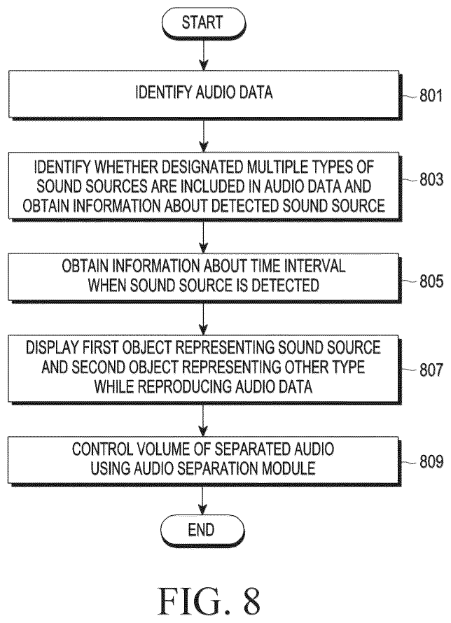

FIG. 8 is a view illustrating an example of an operation method in an electronic device according to one or more embodiments. In the following embodiments, each operation may be performed sequentially, but is not necessarily performed sequentially. For example, the order of the operations may be changed, and at least two operations may be performed in parallel.

Referring to FIG. 8, the electronic device (e.g., the electronic device 101 of FIG. 1) according to one or more embodiments may identify audio data based on receiving a request for individually editing each of a plurality of sound sources included in the audio data in operation 801. The audio data may be stored in the memory. According to one or more embodiments, when receiving an execution request for an audio editing function (e.g., an application related to audio editing), the electronic device may display an execution screen (e.g., the execution screen 510 of FIG. 5A) for audio editing on the display and identify the audio data to be edited through the execution screen.

In operation 803, the electronic device may identify whether sound sources of a plurality of types designated by the audio classification module are included in the audio data through the audio classification module (e.g., the audio classification module 230 of FIG. 2A), obtain information about the detected sound source (e.g., the type of sound source) according to the identification result, and store the obtained information about the sound source in the memory 130.

In operation 805, the electronic device may obtain information about the time interval (e.g., the first time interval) when the sound source of the first type is detected in the audio data based on identifying the sound source of the first type among the plurality of types in the audio data. The first type is a classifiable sound source type designated through the audio classification module, and may be at least one of voice, music, wind, noise, laugh, or crowd. The electronic device may identify at least one classifiable sound source (e.g., voice) respectively corresponding to at least one sound source type among the plurality of types in the first time interval from the audio data. The electronic device may classify sound sources that are not separated into independently classifiable sound sources into other types.

In operation 807, the electronic device may display, on the display (e.g., the display module 160 of FIG. 1 or the display 161 of FIGS. 5A, 5B and 5C), a first screen for editing (e.g., the first screen 530 of FIGS. 5A, 5B and 5C) including a first object (e.g., the object 531a representing the voice of FIGS. 5A, 5B, and 5C) representing the sound source of the first type identified in the first time interval and a second object (e.g., the second object 531b of FIGS. 5A, 5B, and 5C) representing the sound source of the other type (e.g., the second type) while reproducing audio data. Here, the first time interval may mean an interval when the audio separation operation is performed at designated time intervals in the entire reproduction time of the audio data. The electronic device may identify (e.g., detect) the sound source for at least one of the plurality of types (e.g., the types for designated separable sound sources) in the first time interval in the audio data. When the electronic device identifies the first type of sound source (e.g., voice) among the plurality of types, the electronic device may display the first object (e.g., the object representing voice) representing the first type of sound source and the second object representing the identified other type (e.g., the second type) except for the classifiable sound sources on the first screen for editing. The electronic device may display information about the time interval when the first audio is detected on the first screen. Here, the other type (e.g., the second type) may be referred to as noise, but is not limited thereto, and may be referred to as others or by a name designated by the user. For example, the electronic device may display more objects representing other types of sound sources on the first screen in addition to the first object for editing sound sources separated by the audio separation module and the object (e.g., the second object) representing the other type (e.g., noise). For example, the objects (e.g., the objects 531a, 531b, 531c, and/or 531d of FIG. 5B) representing the types of voice, noise, music, and/or wind, respectively, may be displayed on the first screen. The first screen may include information about the time interval for the sound source (e.g., the information 533 about the time interval of FIG. 5A), information about the audio data reproduction time (e.g., the information 535 about the audio data reproduction time of FIG. 5A), an object for adjusting the volume (e.g., the object 537 for adjusting the volume of FIG. 5A), and/or an auto edit button (e.g., the auto edit button 539 of FIG. 5A).

In operation 809, the electronic device may control the volume of the first audio (e.g., voice) corresponding to the sound source of the first type separated using the audio separation module (e.g., the audio separation module 240 of FIG. 2B) based on a user input for the first object.

The electronic device according to one or more embodiments may identify whether the sound source is detected (e.g., present) for each of sound sources separable for each interval t1 to tn in the entire time of the audio data by repeating at a designated time interval t using the audio classification module and store, in the memory (e.g., the memory 130 of FIG. 1), information (e.g., sound source types detected for each time interval) about at least one sound source detected according to the identification result and information (e.g., interval information) about the time interval for each time interval when at least one sound source is detected. The designated plurality of types are types of sound sources detectable (e.g., classifiable) by a designated number according to the performance of the audio classification module and may include voice, music, wind, laugh, and/or crowd, and include noise as the other type. The sound source type described in the disclosure is an example and is not limited thereto, and may be designated by being replaced with, or adding other types of sound sources. According to one or more embodiments, the audio separation module may pre-designate the sound source types (e.g., audio types) by a number smaller than the number of sound source types designated by the audio classification module according to the function (e.g., performance). The sound source types described in the disclosure are described as an example, and is not limited thereto, and some of the designated sound source types may be excluded or replaced with, or add other types of sound sources.

According to one or more embodiments, when detecting a classifiable sound source (e.g., identify whether the sound sources are present), the electronic device may identify the probability value (e.g., the score indicating the detection reliability) in which the sound source is present, and if the identified probability value is larger than a threshold, identify that a classifiable sound source is detected (e.g., present). The electronic device may detect the sound source having an identified probability value smaller than or equal to the threshold as noise.

According to one or more embodiments, when the sound source of the third type (e.g., music) is not detected as a specific type in the first time interval among the plurality of types by the audio classification module, and the third audio (e.g., music) corresponding to the sound source of the third type is separated using the audio separation module, to control or edit the third audio corresponding to the sound source of the third type, the electronic device may separate it into the other type and control or edit the third audio using the object (e.g., the second object 531b representing the other type of FIG. 5A) representing the other type. According to one or more embodiments, the electronic device may control the volume of the second audio corresponding to the sound source of the second type and the volume of the third audio corresponding to the sound source of the third type based on a user input for the third object representing the sound source of the third type. According to one or more embodiments, when the score representing the detection reliability of the sound source of the first type is lower than the designated threshold, the electronic device may apply a visually distinguished effect to the first object representing the sound source of the first type.

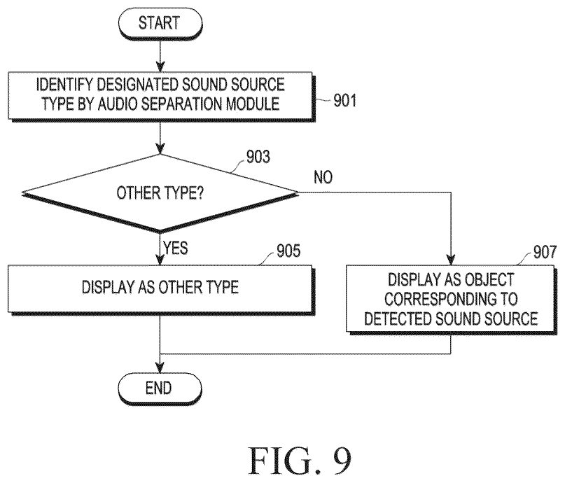

FIG. 9 is a view illustrating an example of an operation method in an electronic device according to one or more embodiments. In the following embodiment, each operation may be sequentially performed, but is not necessarily performed sequentially. For example, the order of the operations may be changed, and at least two operations may be performed in parallel. FIG. 9 illustrates a specific operation for displaying the first screen for editing of the audio data in operation 805 of FIG. 8.

The electronic device according to one or more embodiments may configure objects representing the sound sources included in the first screen for editing (e.g., the first screen 530 of FIGS. 5A, 5B, and 5C) by mapping the sound sources detected for each time interval to the designated audio channels (e.g., the types of audios) in the audio separation module (e.g., the audio separation module 240 of FIG. 2A) in the audio classification module (e.g., the audio classification module 230 of FIG. 2B).

Referring to FIG. 9, in operation 901, the electronic device according to one or more embodiments may identify a plurality of designated sound source types (e.g., audio type or audio channels) separable by the audio separation module. For example, the electronic device may identify the sound source type (e.g., audio type) for the voice, music, wind, and/or other type (e.g., the second type) separable by the audio separation module. Here, the sound source types designated to be separable by the audio separation module may be pre-designated by a smaller number than the number of the designated sound source types in the audio classification module according to the function (e.g., performance) of the audio separation module. The sound source types (e.g., audio type) described in the disclosure are described as an example, and is not limited thereto, and some of the designated sound source types (e.g., audio type) may be excluded or replaced with, or add other types of sound sources. In operation 903, when separating the audio (e.g., sound source) corresponding to some of the plurality of sound source types designated by the audio separation module, the electronic device may identify whether the sound source of the sound source type corresponding to the audio detected or separable from the audio data during audio separation is detected by the audio classification module based on the information about the time interval and the information (e.g., sound source information) about at least one sound source detected by the audio classification module and identify whether the detected or separable audio may be separated into the other audio.

In operation 903, when the sound source (e.g., music) corresponding to the audio (e.g., music) detected or separable during audio separation is not detected during audio classification as the result of the identification, the detected or separable audio (e.g., music) may be separated into the other type (e.g., other audio data) and operation 905 may be performed. In operation 905, the electronic device may display the object (e.g., the second object) corresponding to the other type as an editing UI for controlling or editing the detected or separable audio. Here, the object (e.g., the second object) corresponding to the other type may be referred to as, e.g., other or noise, or by a name (e.g., icon or specific color) designated by the user. For example, the object (e.g., the second object) corresponding to the other type may be an object that is provided to be capable of controlling or editing noise or non-separated other sound sources together with the other type. For example, when the object (e.g., the second object) corresponding to the other type represents a plurality of audios (e.g., sound sources) as other audio not separated as an independent audio (e.g., sound source), noise or non-separated other sound source, the object (e.g., the second object) corresponding to the other type may include sub objects such as an object representing other audio, an object representing noise, or an object representing other audio not separated. When the object (e.g., the second object) corresponding to the other type is selected by the user interaction, an extended object (e.g., screen or UI) displaying sub objects for selecting each of the included sub objects may be displayed on the first screen for editing. Thereafter, when receiving a user input for the second object through the first screen, the electronic device may perform editing or control (e.g., volume control) on the other audio, noise, and/or non-separated other audio.

In operation 903, when the sound source (e.g., music) corresponding to the audio (e.g., music) detected or separable during audio separation is detected during audio classification as the result of the identification, it may be separated into the audio type corresponding to the detected or separable audio (e.g., music), and operation 907 may be performed. In operation 907, the electronic device may display the object corresponding to the separated audio type (e.g., the object corresponding to music) on the first screen for editing. Thereafter, when receiving a user input for the object corresponding to the audio type through the first screen, the electronic device may perform editing or control (e.g., volume control) on the separated audio type of audio.

According to one or more embodiments, when detecting the audios of the plurality of sound source types in the time interval when audio separation is performed through the audio separation module, the electronic device may identify whether to separate each of the plurality of sound source types into the other type by the same operation method as that illustrated in FIG. 9 described above and individually perform the operation of displaying, on the first screen for editing, an object (e.g., editing UI) for control or editing according to the identification result. For example, when a plurality of audio separation modules are configured by the number of separable sound source types, the operations of FIG. 9 may be simultaneously performed on the plurality of sound source types. For example, when one audio separation module is configured, the operations of FIG. 9 may be sequentially performed for each of the plurality of sound source types.

For example, when the score representing the detection reliability of the first type of sound source (e.g., voice) is lower than a designated threshold in the first time interval, the electronic device may apply a visually differentiated effect to the first object (e.g., the object 531a representing voice) representing the first type of sound source, indicating that the probability of the first audio corresponding to the first type of sound source being detected is low. According to one or more embodiments, a visual effect (e.g., a number or graph) representing a control result according to the volume control of the first audio corresponding to the first type of sound source may be applied to the first object.

According to one or more embodiments, when the sound source (e.g., the third sound source) of the third type (e.g., laugh type) detected in the first time interval is detected among the plurality of types by the audio classification module, and it is identified that the third type does not correspond to the audio type separable by the audio separation module, the electronic device may separate the third type of sound source into the second type (e.g., other type) using the audio separation module. The electronic device may together or individually control the volume of the third audio (e.g., other audios not separated into other and/or noise) corresponding to the sound source of the second type and the third audio corresponding to the third type based on a user input for the second object representing the second type.

According to one or more embodiments, when it is identified that the sound source (e.g., third sound source) of the third type (e.g., laugh type) is not separated by the audio separation module, and is a dominant sound source in the audio data, the electronic device may display the third object representing the sound source of the third type on the first screen for editing through the display 161. According to one or more embodiments, the electronic device may individually control the volume of the third audio corresponding to the third sound source based on a user input for the third object. For example, only the sound made by the dog may be detected by the audio classification module, and information about the sound made by the dog may be displayed on the second object representing the sound source of the second type (e.g., other type) of the audio separation module.

According to one or more embodiments, the electronic device may sample the entire audio data by the audio classification module to obtain information and interval information about sound sources detected in the sampling interval, in order to prevent the waiting time before editing from increasing as the processing time increases when the length of the audio data is longer than a designated length. The electronic device may reduce the waiting time before editing based on the information about sound sources and interval information detected in the sampling interval (e.g., the sampling interval 611, 612, and/or 613 of FIG. 6). When the electronic device performs audio classification through the audio classification module using only a portion of the audio rather than the entire audio through sampling, the processor may perform audio control/editing based on the sampling ratio (e.g., probability) for the portion of the audio so as not to miss information about separable sound sources that may be present in the portion of the audio.

When performing audio control/editing based on the sampling rate (e.g., probability) for a portion of audio, if it is a reference value or less, the electronic device may display a screen for editing (e.g., the first screen 530 of FIGS. 5A, 5B, and 5C) including objects (e.g., editing UI) corresponding to all of the separated sound sources output from the audio separation module 240 instead of including objects corresponding to sound sources separated based on the information about the sound source separable from the audio classification module. The electronic device may display an object (e.g., a visual effect of displaying a different color on an icon or an object of the corresponding sound source) on the screen for editing (e.g., the first screen 530 of FIGS. 5A, 5B, and 5C) indicating that information about sound sources detected by the audio classification module may be stochastically less reliable.

According to one or more embodiments, when the information about the time interval identified by the audio classification module is different from the interval information identified by the audio separation module, the electronic device may change the information about the different time intervals, display the changed (e.g., updated) interval information, and display a visual effect or object indicating that the interval information is different on the first screen.

According to one or more embodiments, when selecting an option when reproducing audio data, the electronic device may additionally display an audio waveform separated through the audio separation module on the first screen. Here, the audio waveform may be an audio waveform for the corresponding time interval based on the interval information, and may include an audio waveform of the time axis and/or an audio waveform of the frequency axis.

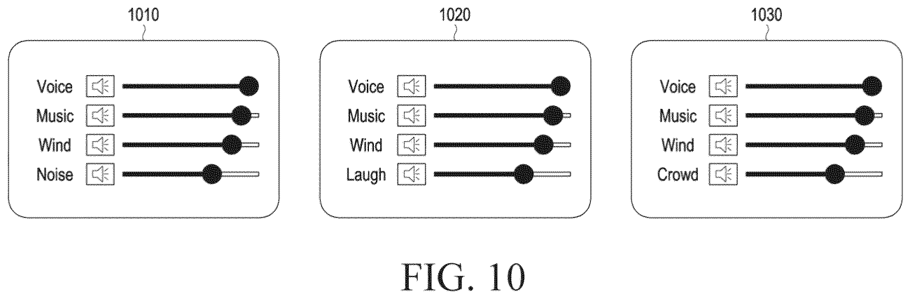

FIG. 10 is a view illustrating an example of a screen for editing audio separated from audio data in an electronic device according to one or more embodiments.

Referring to FIG. 10, according to one or more embodiments, the electronic device may display screens 1010, 1020, and 1030 for editing audios (e.g., sound sources) separated from audio data on the display. For example, as illustrated in FIG. 5A, the screen for editing may be configured to control the volume individually for the objects for the separated audios corresponding to the detected sound sources or, as illustrated in FIG. 10, objects for the separated audios, respectively, may be collected and displayed. The screen for editing may be configured in various other manners.

According to one or more embodiments, when the types of sound sources detected by the audio separation module and the plurality of types designated for audios separable by the audio separation module match, the electronic device may display, on the display, a screen 1010 including the objects respectively corresponding to voice, music, wind, and noise which are the plurality of separable designated types.

According to one or more embodiments, when some (e.g., laugh or crowd) of the types of sound sources detected by the audio classification module do not match the plurality of designated types of the audios separable by the audio separation module (e.g., when there is no audio channel for laugh), the electronic device may display, on the display, the screen 1020 or 1030 in which the object (e.g., laugh or crowd) for the mismatched type of sound source is configured instead of the noise object. For example, the mismatched type of sound source (e.g., laugh or crowd) may be classified as noise and, when the sound source (e.g., laugh or crowd) is separated into noise (e.g., noise channel) from the audio data using the audio separation module, the noise object included in the screen 1010 may be extended so that the object representing the sound source (e.g., laugh or crowd) is displayed together with the noise object.

According to one or more embodiments, a method for operating an electronic device (e.g., the electronic device 101 of FIG. 1) may comprise receiving a request to individually edit each of a plurality of sound sources included in audio data.

According to one or more embodiments, the method may comprise determining, using an audio classification module (e.g., the audio classification module 230 of FIG. 2A), whether the audio data includes sound sources of a plurality of types specified by the audio classification module.

According to one or more embodiments, the method may comprise, based on identifying that a first type of sound source and a second type of sound source among the plurality of types are included in the audio data, displaying, through a display 161 of the electronic device, on a screen for audio editing a first object representing the first type of sound source and the second object representing the second type of sound source.

According to one or more embodiments, the method may comprise, based on a user input for the first object, controlling a volume of a first audio, corresponding to the first type of sound source, separated using an audio separation module (e.g., the audio separation module 240 of FIG. 2B).

According to one or more embodiments, the first object and the second object may be displayed on the screen for audio editing before the audio separation module completes separation of the first audio corresponding to the first type of sound source and a second audio corresponding to the second type of sound source in the audio data.

According to one or more embodiments, the method may further comprise, based on identifying that a first type of sound source and a second type of sound source among the plurality of types are included in the audio data, separating, using the audio separation module, the first audio corresponding to the first type of sound source and the second audio corresponding to the second type of sound source in the audio data.

According to one or more embodiments, the method may further comprise displaying information of a time interval in which the first audio is detected on the screen through the display.

According to one or more embodiments, the method may further comprise, based on determining that a third type of sound source is not detected among the plurality of types by the audio classification module, and a third audio corresponding to the third type of sound source is separated using the audio separation module, controlling a volume of the second audio corresponding to the second type of sound source and a volume of the third audio corresponding to the third type of sound source based on a user input for the second object.

According to one or more embodiments, the method may further comprise, based on determining that a score indicating a detection reliability of the first type of sound source is lower than a specified threshold value, applying, on the screen, a visually distinguishable effect to the first object.

According to one or more embodiments, the method may further comprise applying a visual effect indicating the controlled volume of the first audio to the first object.

According to one or more embodiments, the plurality of types may be a sound source type classifiable through the audio classification module in the audio data.

According to one or more embodiments, in the method, the audio separation module may specify the number of separable audio types to be lower than the number of types specified by the audio classification module, and the plurality of types may include sound source types corresponding to the plurality of audio types.

According to one or more embodiments, the method may further comprise, based on identifying that the third type of sound source is detected among the plurality of types by the audio classification module, and identifying that the third type does not correspond to a separable type by the audio separation module, separating a third audio corresponding to the third type into the second type using the audio separation module and controlling a volume of the third audio based on a user input for the second object.

According to one or more embodiments, the method may further comprise, based on identifying that the third type of sound source is a dominant sound source in the audio data, displaying a third object representing the third type of sound source on the screen through the display, and based on the user input for the object representing the specific type, controlling the volume of the third audio corresponding to the third type of sound source.

According to one or more embodiments, the method may further comprise displaying waveform information on sound sources separable from the audio data on the screen through the display.

According to one or more embodiments, the method may further comprise determining whether the sound sources of the plurality of types specified by the audio classification module are included in a sampled interval from the audio data through the audio classification module.

According to one or more embodiments, in a non-transitory storage medium storing one or more programs, the one or more programs may comprise instructions configured to, when executed by at least one processor (e.g., the processor 120 of FIG. 1) of an electronic device (e.g., the electronic device 101 of FIG. 1), cause the electronic device to receive a request to individually edit each of a plurality of sound sources included in audio data.

According to one or more embodiments, the one or more programs may comprise instructions configured to, when executed by at least one processor of an electronic device, cause the electronic device to determine, using an audio classification module(e.g., the audio classification module 230 of FIG. 2A), whether the audio data includes sound sources of a plurality of types specified by the audio classification module.

According to one or more embodiments, the one or more programs may comprise instructions configured to, when executed by at least one processor of an electronic device, cause the electronic device to, based on identifying that a first type of sound source and a second type of sound source among the plurality of types are included in the audio data, display, through a display (e.g., the display module 160 of FIG. 1, the display 161 of FIGS. 5A, 5B, and 5C) of the electronic device, on a screen for audio editing a first object representing the first type of sound source and the second object representing the second type of sound source.

According to one or more embodiments, the one or more programs may comprise instructions configured to, when executed by at least one processor of an electronic device, cause the electronic device to, based on a user input for the first object, control a volume of a first audio, corresponding to the first type of sound source, separated using an audio separation module (e.g., the audio separation module 240 of FIG. 2B).

According to one or more embodiments, the first object and the second object may be displayed on the screen for audio editing before the audio separation module completes separation of the first audio corresponding to the first type of sound source and a second audio corresponding to the second type of sound source in the audio data.

According to one or more embodiments, it is possible to obtain information about sound sources separable from a sound source file and information about the time interval for each sound source within a short time before editing using an audio classification solution and separate each sound source using an audio separation module in real-time during reproduction, thereby enhancing editing usability. The disclosure supports editing using each sound source separated by executing sound source separation in real-time during reproduction, eliminating the need for a waiting time before editing and hence enhancing usability. Other various effects may be provided directly or indirectly in the disclosure. Effects obtainable from the disclosure are not limited to the above-mentioned effects, and other effects not mentioned may be apparent to one of ordinary skill in the art from the following description.

The embodiments disclosed herein are proposed for description and understanding of the disclosed technology and does not limit the scope of the disclosure. Accordingly, the scope of the disclosure should be interpreted as including all changes or various embodiments based on the technical spirit of the disclosure.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a display;
at least one processor; and
memory storing instructions,
wherein the instructions, when executed by the at least one processor individually or collectively, cause the electronic device to:
receive a request to individually edit each of a plurality of sound sources of audio data;
determine, by an audio classification module, whether the audio data comprises sound sources of a plurality of types specified by the audio classification module, the sound sources of the plurality of types being ones of the plurality of sound sources;
based on identifying that a first type of sound source and a second type of sound source among the plurality of types are of the audio data, display, through the display, a screen indicating audio editing of a first object representing the first type of sound source and a second object representing the second type of sound source; and
based on a user input to the screen and indicating the first object, control a volume of a first audio corresponding to the first type of sound source and at least partly separated using an audio separation module,
wherein the first object and the second object are displayed on the screen before the audio separation module completes separation of the first audio, as corresponding to the first type of sound source, and a second audio, as corresponding to the second type of sound source, in the audio data.

2. The electronic device of claim 1, wherein the instructions, when executed by the at least one processor individually or collectively, further cause the electronic device to:
based on identifying that the first type of sound source and the second type of sound source among the plurality of types are of the audio data, separate, using the audio separation module, the first audio corresponding to the first type of sound source and the second audio corresponding to the second type of sound source in the audio data, and display information, of a time interval in which the first audio is detected, on the screen through the display.

3. The electronic device of claim 1, wherein the instructions, when executed by the at least one processor individually or collectively, further cause the electronic device to:
based on both a third type of sound source being determined as not detected among the plurality of types by the audio classification module and also a third audio corresponding to the third type of sound source being determined as at least partly separated using the audio separation module, control a volume of the second audio, corresponding to the second type of sound source, and a volume of the third audio, corresponding to the third type of sound source, based on a user input indicating the second object.

4. The electronic device of claim 1, wherein the instructions, when executed by the at least one processor individually or collectively, further cause the electronic device to:
based on determining that a score indicating a detection reliability of the first type of sound source is lower than a specified threshold value, apply, on the screen, a visually distinguishable effect to the first object.

5. The electronic device of claim 1, wherein the instructions, when executed by the at least one processor individually or collectively, further cause the electronic device to:
apply a visual effect, on the screen and indicating a controlled volume of the first audio, to the first object,
wherein the plurality of types are sound source types classifiable through the audio classification module in the audio data,
wherein the audio separation module specifies a number of separable audio types to be lower than a number of types specified by the audio classification module, and
wherein the plurality of types comprise the sound source types corresponding to the plurality of types.

6. The electronic device of claim 3, wherein the instructions, when executed by the at least one processor individually or collectively, further cause the electronic device to:
based on identifying that the third type of sound source is detected among the plurality of types by the audio classification module and identifying that the third type does not correspond to a separable type by the audio separation module, separate the third audio corresponding to the third type into the second type using the audio separation module and control the volume of the third audio based on the user input indicating the second object.

7. The electronic device of claim 3, wherein the instructions, when executed by the at least one processor individually or collectively, further cause the electronic device to:
based on identifying that the third type of sound source is a dominant sound source in the audio data, display a third object representing the third type of sound source on the screen through the display; and
based on the user input indicating the third object and representing a specific type, control the volume of the third audio corresponding to the third type of sound source.

8. The electronic device of claim 1, wherein the instructions, when executed by the at least one processor individually or collectively, further cause the electronic device to:
display waveform information on the sound sources as separable from the audio data on the screen through the display.

9. The electronic device of claim 1, wherein the instructions, when executed by the at least one processor individually or collectively, further cause the electronic device to:
determine whether the sound sources of the plurality of types specified by the audio classification module are of a sampled interval from the audio data through the audio classification module.

10. A method for operating an electronic device, the method comprising:
receiving a request to individually edit each of a plurality of sound sources of audio data;
determining, by an audio classification module, whether the audio data comprises sound sources of a plurality of types specified by the audio classification module, the sound sources of the plurality of types being ones of the plurality of sound sources;
based on identifying that a first type of sound source and a second type of sound source among the plurality of types are of the audio data, displaying, through a display of the electronic device, a screen indicating audio editing of a first object representing the first type of sound source and a second object representing the second type of sound source; and
based on a user input to the screen and indicating the first object, controlling a volume of a first audio corresponding to the first type of sound source and at least partly separated using an audio separation module,
wherein the first object and the second object are displayed on the screen before the audio separation module completes separation of the first audio, as corresponding to the first type of sound source, and a second audio, as corresponding to the second type of sound source, in the audio data.

11. The method of claim 10, further comprising:
based on identifying that the first type of sound source and the second type of sound source among the plurality of types are of the audio data, separating, using the audio separation module, the first audio corresponding to the first type of sound source and the second audio corresponding to the second type of sound source in the audio data; and
displaying information of a time interval in which the first audio is detected on the screen through the display.

12. The method of claim 10, further comprising, based on both a third type of sound source being determined as not detected among the plurality of types by the audio classification module and also a third audio corresponding to the third type of sound source being determined as at least partly separated using the audio separation module, controlling a volume of the second audio corresponding to the second type of sound source and a volume of the third audio, corresponding to the third type of sound source, based on a user input indicating the second object.

13. The method of claim 10, further comprising, based on determining that a score indicating a detection reliability of the first type of sound source is lower than a specified threshold value, applying, on the screen, a visually distinguishable effect to the first object.

14. The method of claim 10, further comprising:
applying a visual effect, on the screen and indicating a controlled volume of the first audio, to the first object.

15. The method of claim 10,
wherein the plurality of types are sound source types classifiable through the audio classification module in the audio data,
wherein the audio separation module specifies a number of separable audio types to be lower than a number of types specified by the audio classification module, and
wherein the plurality of types comprise the sound source types corresponding to the plurality of types.

16. The method of claim 12, further comprising, based on identifying that the third type of sound source is detected among the plurality of types by the audio classification module, and identifying that the third type does not correspond to a separable type by the audio separation module, separating the third audio corresponding to the third type into the second type using the audio separation module and controlling the volume of the third audio based on the user input indicating the second object.

17. The method of claim 12, further comprising:
based on identifying that the third type of sound source is a dominant sound source in the audio data, displaying a third object representing the third type of sound source on the screen through the display; and
based on the user input indicating the third object and representing a specific type, controlling the volume of the third audio corresponding to the third type of sound source.

18. The method of claim 10, further comprising displaying waveform information on the sound sources as separable from the audio data on the screen through the display.

19. The method of claim 10, further comprising determining whether the sound sources of the plurality of types specified by the audio classification module are of a sampled interval from the audio data through the audio classification module.

20. A non-transitory storage medium storing one or more programs including instructions configured to, when executed by at least one processor of an electronic device, cause the electronic device to:
receive a request to individually edit each of a plurality of sound sources of audio data;
determine, by an audio classification module, whether the audio data comprises sound sources of a plurality of types specified by the audio classification module, the sound sources of the plurality of types being ones of the plurality of source sources;
based on identifying that a first type of sound source and a second type of sound source among the plurality of types are of the audio data, display, through a display of the electronic device, a screen indicating audio editing of a first object representing the first type of sound source and a second object representing the second type of sound source; and
based on a user input to the screen and indicating the first object, control a volume of a first audio corresponding to the first type of sound source and at least partly separated using an audio separation module,
wherein the first object and the second object are displayed on the screen before the audio separation module completes separation of the first audio, as corresponding to the first type of sound source, and a second audio, as corresponding to the second type of sound source, in the audio data.
